(19) United States
(12) Patent Application Publication
(10) Pub. No.: US 2025/0335051 A1
(43) Pub. Date: Oct. 30, 2025

(54) TOUCH IC COMMUNICATION

(71) Applicant: STMicroelectronics International N.V., Geneva (CH)

(72) Inventors: Pengcheng Wen, Beijing (CN); Yue Ding, Beijing (CN); Yuan Yun Wang, New Taipei City (TW)

(21) Appl. No.: 18/650,968

(22) Filed: Apr. 30, 2024

(51) Int. Cl. G06F 3/041; G06F 3/044

(52) U.S. Cl. CPC G06F 3/0416; G06F 3/0446; G06F 2203/04102

(57) ABSTRACT

A touch screen device including a first touch panel, a first touch controller, a second touch panel arranged opposite from the first touch panel, and a second touch controller configured to receive data from the first touch controller, perform a calculation on the received data, and send a result of the calculation data to the first touch controller.

### TECHNICAL FIELD

The present invention relates generally to touch screen devices, and, in particular embodiments, to a method for communication between multiple touch panels.

### BACKGROUND

Touch screens are commonly used in electronic devices, such as tablets, smartphones, and computers. In recent years, there has been a push away from the more traditional methods, as consumers prefer the convenience of portable devices that can support a more flexible lifestyle. To this end, there has been a rise in smaller, portable, hand-held electronic devices, such as mobile phones, tablets, gaming systems, etc. This has given rise to the popularity of touch screens and touch panel displays with larger screens that remain portable. Not only do they provide the functionality of the traditional electronic devices, but touch screens provide additional features.

Some electronic devices may include multiple touch panels in a single touch screen device or system, for example, foldable touch screen smartphones and tablets. For example, a foldable smartphone features a flexible display that can be folded or unfolded to expose or conceal a larger screen area, effectively transforming between a compact, single-screen configuration and an expanded, tablet-like form factor. These devices incorporate one or more hinges or bending zones that allow the screen to fold without damage. Accompanying this flexible display, the device integrates an adaptable user interface that adjusts the content presentation as the phone's form changes.

### SUMMARY

Embodiments of the invention provide a method of communication between independent touch panels. As discussed below, embodiments relate to touch screen devices that include multiple touch panels.

One general aspect includes a touch screen device that includes a first touch panel having a first main touch surface, a first touch controller coupled to the first touch panel, a second touch panel having a second main touch surface arranged opposite from the first main touch surface of the first touch panel, and a second touch controller coupled to the second touch panel and configured to receive data from the first touch controller, to perform a calculation on the received data, and to send a result of the calculation data to the first touch controller.

Another general aspect includes a touch screen device that includes a first touch panel having a first main touch surface, a first touch controller configured to detect touch on the first touch panel, a second touch panel having a second main touch surface arranged opposite from the first main touch surface of the first touch panel, and a second touch controller configured to detect touch on the second touch panel. The first touch controller is configured to communicate with the second touch controller to disable a zone of touch channels on the second touch panel when touch is detected on a zone of touch channels on the first touch panel.

Another general aspect includes a method of operating a touch screen device, the method includes detecting touch information in a first zone on a first touch panel, detecting touch information in a second zone on the first touch panel, initiating communication between the first touch panel and a second touch panel, the second touch panel arranged opposite from the first touch panel, and disabling communication channels in a first zone on the second touch panel in response to detecting touch in the first and second zone on the first touch panel. Other embodiments and variations are described herein.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1A-1E show a schematic representation of a dual-sided touch screen device according to an embodiment of the present application;

FIGS. 2A and 2B show a schematic representation of communication between touch controllers or touch ICs according to an embodiment of the present application;

FIGS. 3A and 3B show a diagram of communication channels on a foldable touch screen device according to an embodiment of the present application;

FIGS. 4A-4C show a schematic representation of a foldable touch screen device according to an embodiment of the present application;

FIGS. 5A-5C show a schematic representation of a foldable touch screen device according to another embodiment of the present application;

FIGS. 6A-6D show a schematic representation of a dual-sided touch screen device and a schematic representation of communication between touch controllers according to an embodiment of the present application; and

FIG. 7 shows a flowchart of a method of operating a dual-sided touch screen device according to an embodiment of the present application.

### DETAILED DESCRIPTION OF ILLUSTRATIVE EMBODIMENTS

Embodiments of the present invention relate to a touch screen device having multiple touch screen panels that can communicate among each other within the device. Various embodiments of the present application disclose a device and a method to detect grip by a user using a touch screen device having multiple touch screen panels.

To improve the user experience of a touch screen device having multiple touch panels, a first touch controller of a first touch panel and a second touch controller of a second touch panel may communicate bi-directionally. The first touch controller may send and receive touch input data, such as noise status, grip data, and temperature, to and from the second touch controller. The second touch controller can use the touch input data to improve its performance on the second touch panel.

Touch controllers can detect input signals, such as a finger touch or a stylus, and convert the input signal into a measurable signal to be calculated and processed by controller software algorithms to determine the touch position on the screen. Known touch screen devices having multiple touch screen panels do not typically communicate among each other through the touch controllers. In general, each touch controller acts independently of other touch controllers within the same device.

Embodiments of the invention can provide efficient computing and better performance by utilizing idle integrated circuits (ICs) in the system and distributing the computing power among all available integrated circuits. Embodiments of the invention can also address issues that arise when touchscreens unintentionally report the user's input when the user is handling the device in a way that typically does not indicate the user's intent to make a selection on the touchscreen.

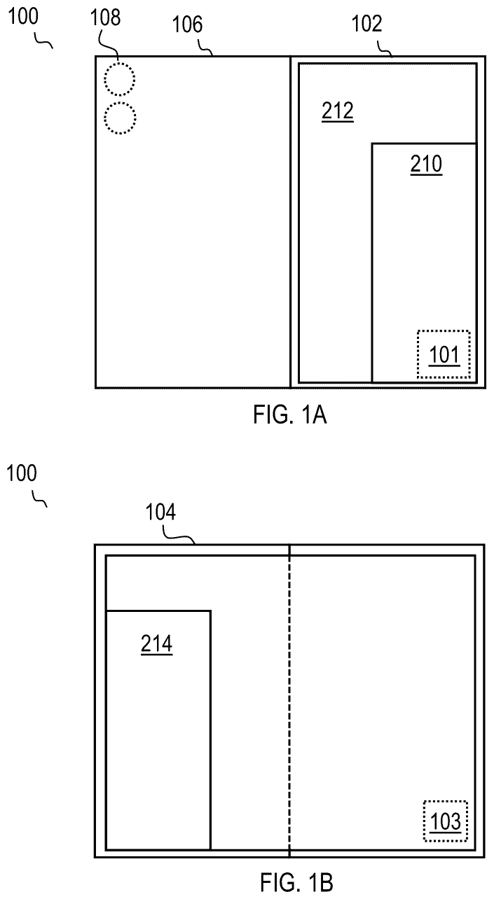

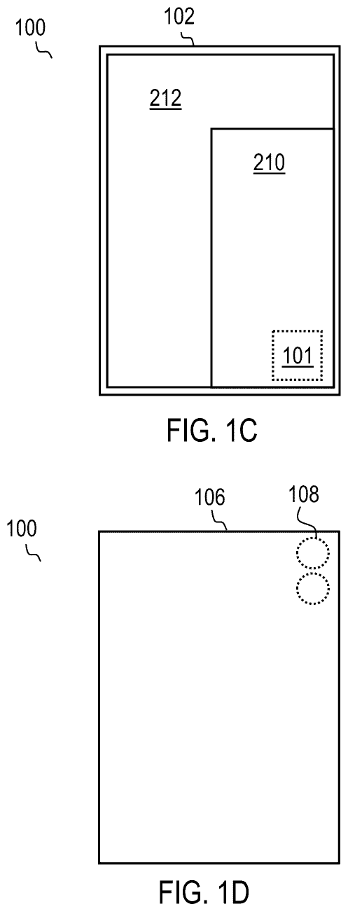

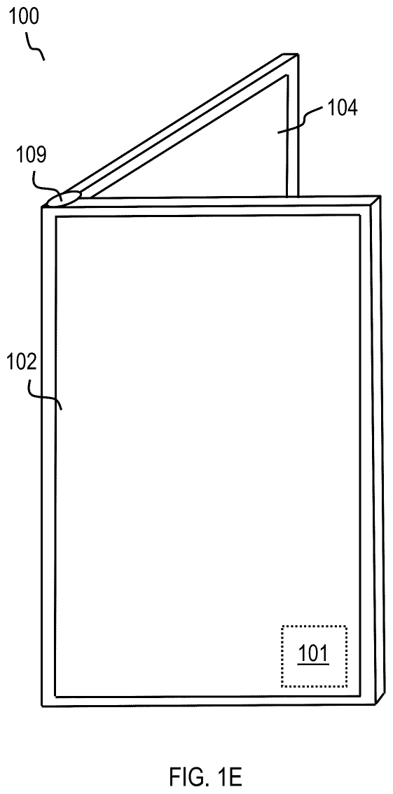

FIGS. 1A-1E (collectively “FIG. 1”) show a schematic representation of a dual-sided touch screen device according to an embodiment of the present application.

As shown in FIG. 1, the touchscreen can be foldable, although this feature is not necessary. FIG. 1A illustrates an outer view of a dual-sided touch screen device 100 when it is open. FIG. 1B illustrates an inner view of the dual-sided touch screen device 100 when it is open. FIG. 1C illustrates a front view of the dual-sided touch screen device 100 when it is folded closed. FIG. 1D illustrates a rear view of the dual-sided touch screen device 100 when it is folded closed. Finally, FIG. 1E illustrates the front view of the dual-sided touch screen device 100 when it is partially folded. In various embodiments, the dual-sided touch screen device may be incorporated in a tablet, computer, smart phone, handheld gaming unit, or similar electronic devices.

Referring to FIG. 1A, the opened outer view of the dual-sided touch screen device 100 includes an outer touch panel 102 and a rear cover 106. Referring to FIG. 1B, the opened inner view of the dual-sided touch screen device 100 includes an inner touch panel 104. In various embodiments, the outer touch panel 102 and inner touch panel 104, may also be referred to together as touch panels, may have the same components and functionally operate in the same manner. Alternatively, the touch panels may have different components. For example, one panel may be a mutual capacitive touch screen and the other a self-capacitance touchscreen.

While the outer touch panel 102 is positioned on a user's left-hand side in FIGS. 1A-1D, the outer touch panel may also be positioned, for example, on a right-hand side, on a top half, on a bottom half, or on a top half and bottom half of the outer portion of the touch screen device. In one or more embodiments, the outer touch panel 102 may be a side facing away from the user while in use and the inner touch panel 104 may be a side facing towards the user while in use when the dual-sided touch screen device is not foldable.

In one or more embodiments, the dual-sided touch screen device 100 may be foldable where the inner touch panel 104 cannot be accessed by the user when the dual-sided touch screen device 100 is fully closed. FIGS. 1C and 1D show a closed outer view of the dual-sided touch screen device 100 and FIG. 1E shows a partially folded view of the dual-sided touch screen device 100. FIG. 1C shows the front view of the dual-sided touch screen device 100 which includes the outer touch panel 102 previously shown in FIG. 1A. FIG. 1D shows the rear view of the of the dual-sided touch screen device 100 which includes a rear cover 106 and a plurality of camera lenses 108. FIG. 1E shows the partially folded view of the dual-sided touch screen device which shows the outer touch panel 102, inner touch panel 104, and hinges 109. For example, the dual-sided touch screen device 100 may include vertically positioned hinges allows the left half to fold over the right half of the device, e.g., as shown in FIG. 1E, or horizontally positioned hinges that allow the top half to fold over the bottom half of the device.

In various embodiments, the touch panels may each include a plurality of touch sensors and a touch controller or touch IC. For example, the plurality of touch sensors may be arranged in rows and columns across the outer touch panel 102 and the inner touch panel 104 as discussed below.

In one or more embodiments, the outer touch panel 102 may have an outer touch controller 101 and the inner touch panel 104 may have an inner touch controller 103. The locations and shapes shown in the figures are arbitrary and only intended to indicate the existence of the controllers.

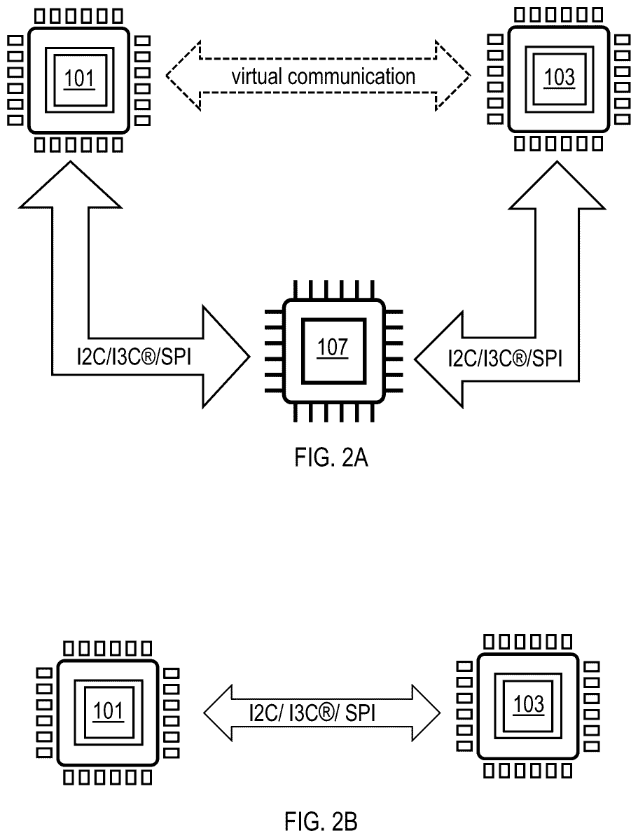

The outer touch controller 101 and the inner touch controller 103 may communicate bi-directionally as described with respect to FIGS. 2A-2B. When the dual-sided touch screen device 100 is opened, the inner touch controller 103 is in an active state and the plurality of touch sensors on the inner touch panel 104 are enabled to detect touch by a user, e.g. finger touch, palm touch, or stylus/pen touch. On the other hand, the outer touch controller 101 is in an idle state and the plurality of touch sensors of the outer touch panel 102 may also be enabled to detect touch by a user. The plurality of touch sensors on the outer touch panel 102 and the inner touch panel 104 may collect raw data corresponding to interactions on the touch panel and send and receive data from the other touch panel to perform calculations.

FIGS. 2A and 2B show a schematic representation of communication between touch controllers or touch ICs according to an embodiment of the present application. The touch controllers will be described in conjunction with FIGS. 1A-1D.

FIG. 2A shows a schematic representation of communication between touch controllers or touch ICs. In one or more embodiments, the outer touch controller 101 may communicate with inner touch controller 103 through a host 107 without additional physical channels. The touch controllers 101 and 103 may communicate with the host 107 using auxiliary I2C/I3C/SPI channels. The host 107 may be, for example, a host IC. While FIG. 2A illustrates two touch controllers as an example, various embodiments of the invention may include more than two touch controllers.

FIG. 2B shows another schematic representation of communication between outer touch controller 101 and inner touch controller 103. Outer touch controller 101 and inner touch controller 103 may directly communicate among each other using auxiliary I2C/I3C/SPI channels or through other communication methods, for example, by utilizing general-purpose input/output (GPIO) pins.

Touch controllers generally work by processing touch commands for the operating system to respond accordingly. In one or more embodiments, the outer touch controller 101 and inner touch controller 103 may be an active touch IC or an idle touch IC. The active touch IC can collect and transfer raw data to an idle touch IC. The idle touch IC can calculate the raw data with a pre-arranged algorithm and send the results back to the active touch IC. The raw data may include IC status information, basic environment parameters, and grip related information. Some examples of IC status information and basic environment parameters may include IC state, host state, noise state, noise frequency, and temperature. Some examples of grip related information may include the shape and characteristics of the device. In various embodiments, touch controllers 101 and 103 may be implemented in a tablet, computer, smart phone, handheld gaming unit, or similar electronic devices.

For example, inner touch controller 103 may be the active touch IC and outer touch controller 101 may be the idle touch IC. The inner touch controller 103 can send raw data to be calculated by outer touch controller 101. In this way, the idle touch IC can be utilized to reduce the workload typically handled by the active touch IC. Thus, the active touch IC can have more computing power to handle process other touch commands. In addition, more complex or time-consuming algorithms can be used for touch processing. For example, training non real-time data with machine learning arithmetic can be time-consuming. When the data is calculated by the active touch IC, a high report rate cannot be achieved. On the other hand, when the data is calculated by the idle touch IC, computing power can be doubled resulting in better performance and a high report rate can be achieved.

In one or more embodiments, the touch controllers may share information among one another to balance the computing power among the plurality of touch controllers. For example, outer touch controller 101 and inner touch controller 103 can share information among each other to balance out the computing power to get better performance without adding additional circuitry. For example, the touch controllers may share grip, noise, temperature and other information, touch IC get better grip/noise performance. Computing power can be shared among active touch IC and idle touch IC, allowing the active touch IC to have more power.

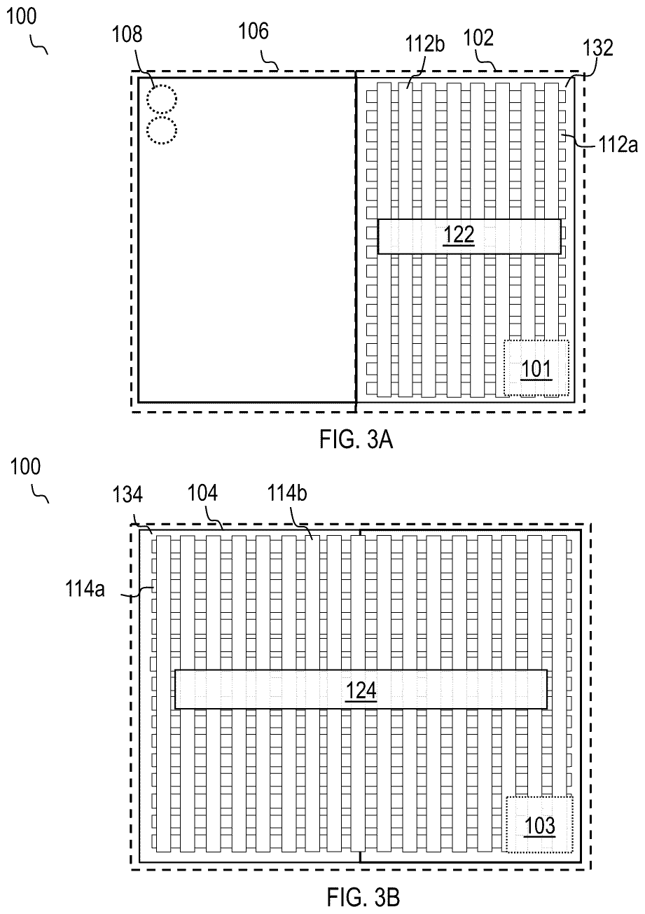

FIGS. 3A and 3B shows a diagram of communication channels on a foldable touch screen device according to an embodiment of the present application. FIGS. 3A and 3B will be described in conjunction with FIGS. 1A-1D and FIGS. 2A-2B as one example of an embodiment of the present application.

As shown in FIGS. 3A-3B, touch panels 102, 104 may include a display layer 132, 134, a matrix sensor 122, 124, and a plurality of communication channels arranged in rows and columns across the touch panels 102, 104. For example, referring to FIG. 3A, the outer touch panel 102 may include an outer display layer 132, an outer matrix sensor 122, and a plurality of communication channels arranged in rows and columns. The plurality of communication channels on the outer touch panel 102 may include transmitting (TX) touch sensors 112a and receiving (RX) touch sensors 112b (collectively referred to as “touch sensors”). Referring to FIG. 3B, the inner touch panel 104 may include an inner display layer 134, an inner matrix sensor 124, and a plurality of communication channels arranged in rows and columns. The plurality of communication channels on the inner touch panel 104 may include transmitting (TX) touch sensors 114a and receiving (RX) touch sensors 114b.

The TX touch sensors may also be referred to as TX electrodes or TX channels. The RX touch sensors may also be referred to as RX electrodes or RX channels. The TX touch sensors 112a, 114a and RX touch sensors 112b, 114b may span the entirety of the touch panel in a grid-like fashion that are operable by a touchscreen controller. In various embodiments, the TX touch sensors 112a, 114a may be formed in rows across the touch screen panel and the RX touch sensors 112b, 114b may be formed in columns across the touch panel. In other embodiments, the RX touch sensors 112b, 114b may be formed in rows across the touch screen panel and the TX touch sensors 112a, 114a may be formed in columns across the touch screen panel. The TX touch sensors 112a, 114a and the RX touch sensors 112b, 114b may overlap in certain embodiments.

The touch sensors 112a, 112b, 114a, 114b may be formed by electrically coupling the touchscreen to rows of capacitive electrodes and columns of capacitive electrodes that span the entirety of the touchscreen. The touch sensors 112a, 112b, 114a, 114b have a measurable mutual capacitance at their intersections. In addition, each touch sensor 112a, 112b, 114a, 114b may have a self-capacitance that may be measured with respect to ground. The touch controller may be coupled to the touch sensors 112a, 112b, 114a, 114b. When the touch sensors 112a, 112b, 114a, 114b receive a touch signal, the touch sensor 112a, 112b, 114a, 114b transmits the touch signals to the touch controller and the touch controller processes the touch signals.

The RX touch sensors 112b, 114b and TX touch sensors 112a, 114a may be enabled or disabled when a user's touch is detected by the matrix sensors 122, 124. In one or more embodiments, the matrix sensors 122, 124 may transmit data from the plurality of communication channels to a touch controller 101, 103. For example, the inner matrix sensor 124 may transmit data received from the plurality of touch sensors 114a, 114b and transmit data to the inner touch controller 103. The data from the touch sensors may be transmitted from the inner touch controller 103 to a host 107 or directly to outer touch controller 101. In various embodiments, the data from the touch sensors 112a, 112b may be received by inner touch controller 103 from outer touch controller 101.

The touch controller may be coupled to the TX touch sensors 112a, 114a and the RX touch sensors 112b, 114b. During a touch sensing operation or a touch scan operation, the touch controller may transmit touch driving signals to the TX touch sensors 112a, 114a and receive touch sensing signal from the RX touch sensors 112b, 114b. When a finger presses on an intersection of one TX touch sensor 112a, 114a and one RX touch sensor 112b, 114b, the mutual capacitance or self-capacitance of these sensors will be changed. Thus, the finger touch will be detected and the touch sensing signals will change. The touch controller may measure and analyze the touch sensing signals, and report touch coordinates to the host 107.

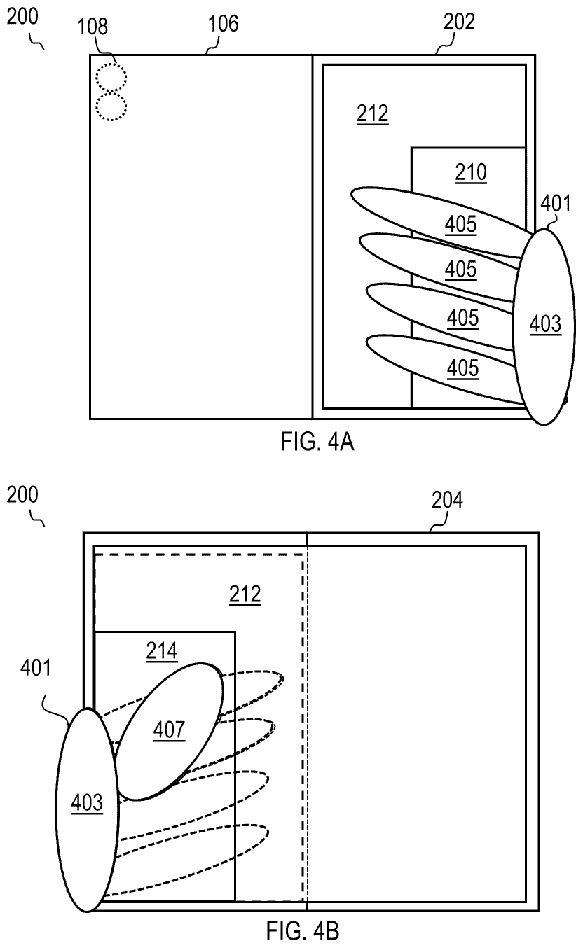

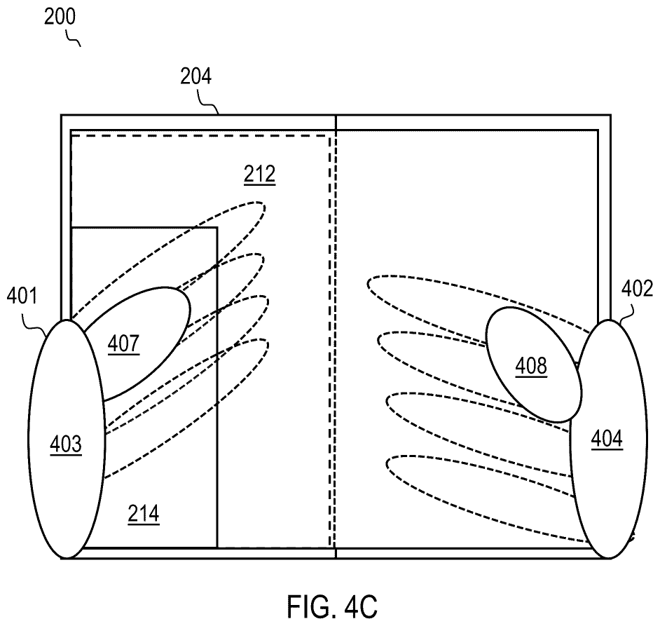

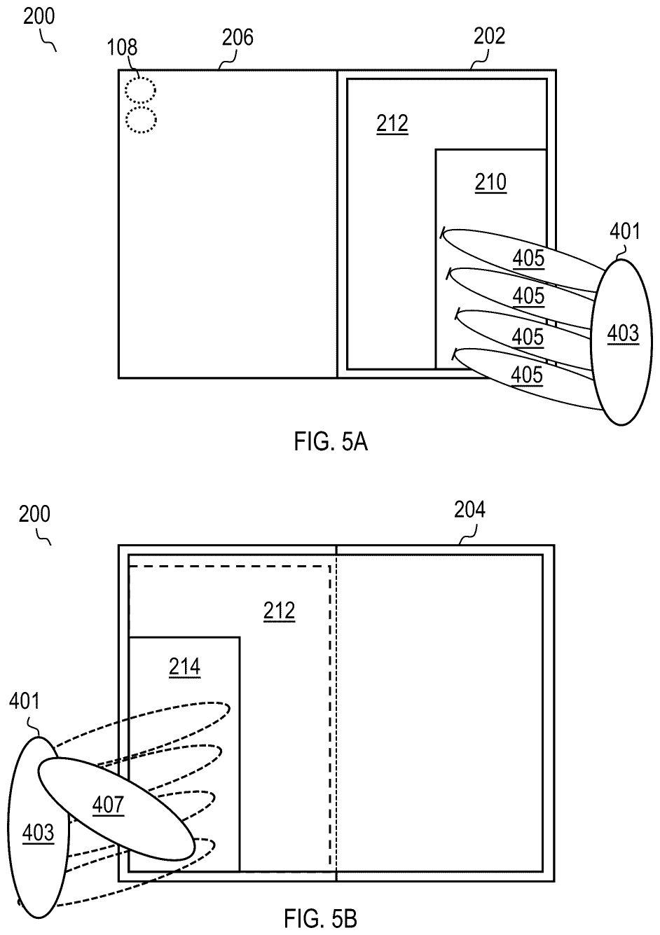

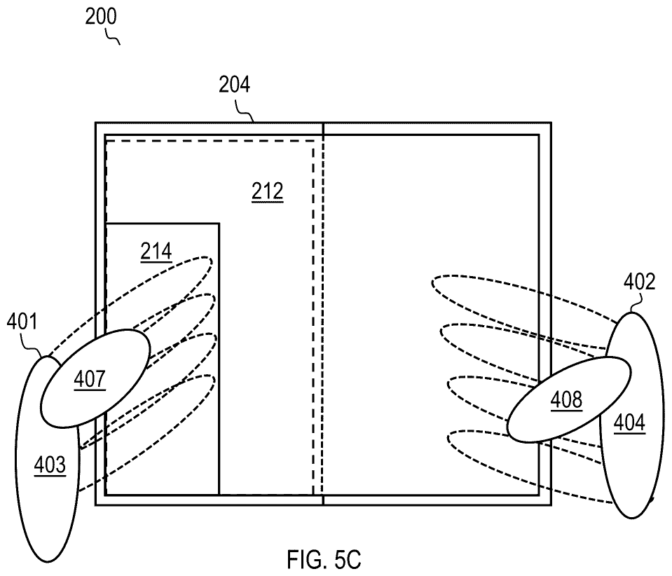

FIGS. 4A-4C show a schematic representation of a foldable touch screen device according to an embodiment of the present application and FIGS. 5A-5C show a schematic representation of a foldable touch screen device according to another embodiment of the present application.

FIGS. 4A-4C and 5A-5C will be discussed in conjunction with FIGS. 1A-1B, 2A-2B, and 3A-3B. FIGS. 4A and 5A illustrate an outer view of a touch screen device 200 when it is open and a user is holding the left-hand side of the device. FIGS. 4B and 5B illustrates an inner view of the touch screen device 200 when it is open and the user is holding the left-hand side of the device. FIGS. 4C and 5C illustrates an inner view of the touch screen device 200 when it is open and the user is holding the devices with both hands, i.e., the left-hand side and the right-hand side. Although the user's hand position is shown on the left-hand side and the right-hand side in FIGS. 4A-4C and 5A-5C, embodiments of the present application can also apply when the user's hands are in other positions including on the bottom, center, or top of the device.

In one or more embodiments, the touch screen device 200 may be held by a user with one hand 401 as shown in FIGS. 4A-4B and 5A-5B. In other embodiments, the touch screen device 200 may be held by a user with two hands 401, 402 as shown in FIGS. 4C and 5C. When the touch screen device 200 is opened, the outer touch panel 202 is in an idle state and the inner touch panel 204 is in an active state. The user may be using the inner touch panel 204, for example, to read or watch videos, play games, make notes, etc. While the user is using the touch screen device 200, the user's hand positioning may change based whether the user intends to make a selection on the inner touch panel.

When the user does not intend to make a selection on the inner touch panel 204, the user's hand positioning may not change frequently and a larger surface area of the touch screen device may be covered by the user's hand 401, 402, i.e., in order to engage a steady grip on the touch screen device. On the other hand, when the user intends to make a selection on the inner touch panel, the user's hand positioning may change frequently and a smaller surface area, compared to no selection by the user, may be covered by the user's hand 401, 402, i.e., in order for the user to reach a large portion of the inner touch panel with their thumbs 407, 408.

In one or more embodiments, when the touch sensor detects touch on the outer touch panel 202, the outer touch controller 101 sends auxiliary grip information of the outer touch panel 202 to the inner touch controller 103. The inner touch controller 103 decides whether touch, e.g., by a user's thumb 407, 408, on an edge of the inner touch panel 204 should be reported or not.

Referring to FIGS. 4A-4C, when the user has a steady grip on the touch screen device 200 and a large surface area of the outer touch panel 202 is covered by the user's hand 401, 402, touch detected at bottom right corner of the inner touch panel 204 should not be reported with great probability. For example, when the user has a steady grip on the touch screen device 200 for activities, such as reading or watching videos, the user's fingers 405 and palms 403, 404 may be in contact with a portion of the outer touch panel 202 and the user's thumb 407, 408 may be in contact with a portion of the inner touch panel 204. The area of contact by the user's thumb 407, 408 should not be reported in this example.

In various embodiments, the inner touch controller 103 may temporarily disable the TX touch channels 114a and RX touch channels 314b aligned with the user's thumb 407, 408 on the inner touch panel 204 to prevent unintended selection on the inner touch panel 204 while in a steady grip.

Referring to FIGS. 5A-5C, when the user intends to make a selection on the inner touch panel 204, the user's hands 401, 402 positioning may change frequently and a smaller surface area, compared to no selection by the user, of the outer touch panel 202 may be covered by the user's hands 401, 402. For example, when the user is using the touch screen device for activities, such as playing games, the user's fingers 405 may be in contact with the outer touch panel 202 and the user's thumb 407, 408 may be in contact with a portion of the inner touch panel 204, however, the user's palm may not be in contact with the outer touch panel 202. The area of contact by the user's thumb 407, 408 should be reported in this example.

In various embodiments, when the user's palm 403, 404 is not in contact with the outer touch panel 202, the TX touch sensors 114a and RX touch sensors 114b are all enabled to send a signal to the inner touch controller 103. In this context, “all sensors” refer to all communication channels being used in the specific application being implemented at that time.

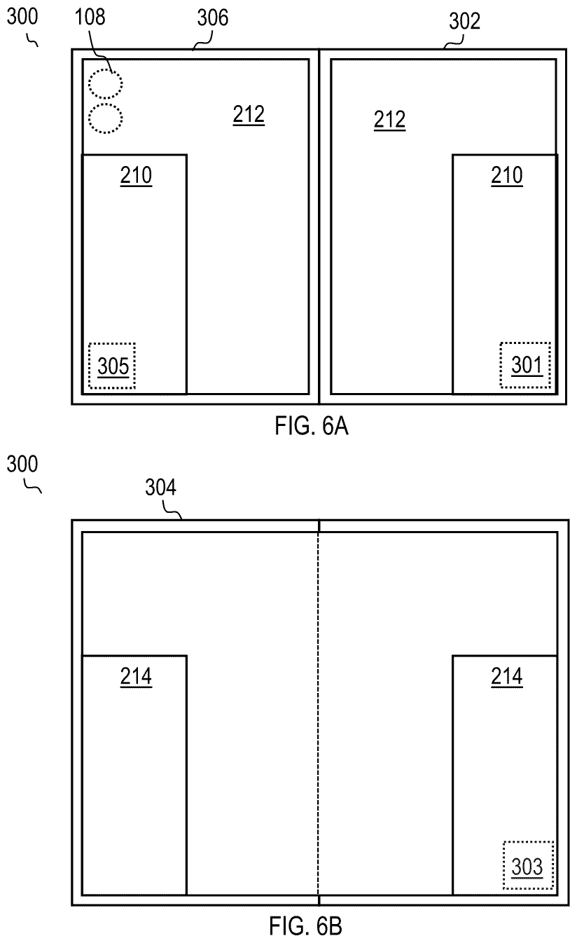

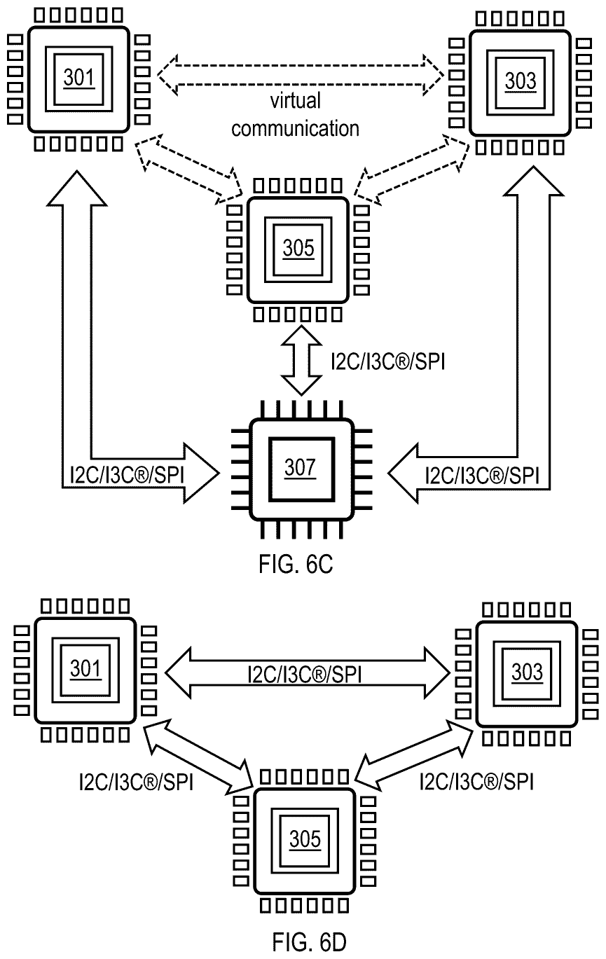

FIGS. 6A-6B show a schematic representation of a dual-sided touch screen device according to an embodiment of the present application and FIGS. 6C-6D show a schematic representation of communication between touch controllers according to an embodiment of the present application. FIG. 6A illustrates an outer view of a dual-sided touch screen device 300. FIGS. 6B illustrates an inner view of the dual-sided touch screen device 300 of FIG. 6A. The dual-sided touch screen device illustrated in this figure is similar to that discussed with respect to FIGS. 1A-1D and the communication between touch controllers is similar to that discussed with respect to FIGS. 2A-2B. As such, many of the details will not be repeated.

Referring to FIG. 6A, the opened outer view of the dual-sided touch screen device 300 includes a front side touch panel 302 and a rear side touch panel 306. The front side touch panel 302 includes a front-side touch controller 301 and the rear side touch panel 306 includes a rear-side touch controller 305. Referring to FIG. 6B, the opened inner view of the dual-sided touch screen device 300 includes an inner touch panel 304. The inner touch panel 304 include an inner touch sensor 303. As shown in FIG. 6A-6B, the touchscreen can be foldable, although this feature is not necessary.

In one or more embodiments, the front side touch panel 302 and the rear side touch panel 306 may be two separate touch panels with independent touch controllers 301, 305. In other embodiments, the front side touch panel 302 and the rear side touch panel 306 may be a single touch panel extending across the right-hand side and left-hand side of the touch screen device.

FIGS. 6C-6D show a schematic representation of communication between touch controllers. In one or more embodiments, the front-side touch controller 301, rear-side touch controller 305, and inner touch controller 303 may communicate through a host 307 without additional physical channels. The touch controllers 301, 303, 305 may communicate with the host 307 using auxiliary I2C/I3C/SPI channels. While FIGS. 6A-6B illustrates three touch controllers as an example, various embodiments of the invention may include more than three touch controllers.

FIG. 6D shows another schematic representation of communication between the front-side touch controller 301, rear-side touch controller 305, and inner touch controller 303. In one or more embodiments, the front-side touch controller 301, rear-side touch controller 305, and inner touch controller 303 may directly communicate among each other using auxiliary I2C/I3C/SPI channels.

In one or more embodiments, the front-side touch controller 301, rear-side touch controller 305, and inner touch controller 303 may be an active touch IC or an idle touch IC. The active touch IC can collect and transfer raw data to an idle touch IC. The idle touch IC can calculate the raw data with a pre-arranged algorithm and send the results back to the active touch IC. The idle touch IC can be utilized to reduce the workload typically handled by the active touch IC. Thus, the active touch IC can have more computing power to handle process other touch commands.

In one or more embodiments, the touch controllers 301, 303, 305 may share information among one another to balance the computing power among the plurality of touch controllers. For example, touch controllers 301, 303, 305 can share information among each other to balance out the computing power to get better performance without adding additional circuitry.

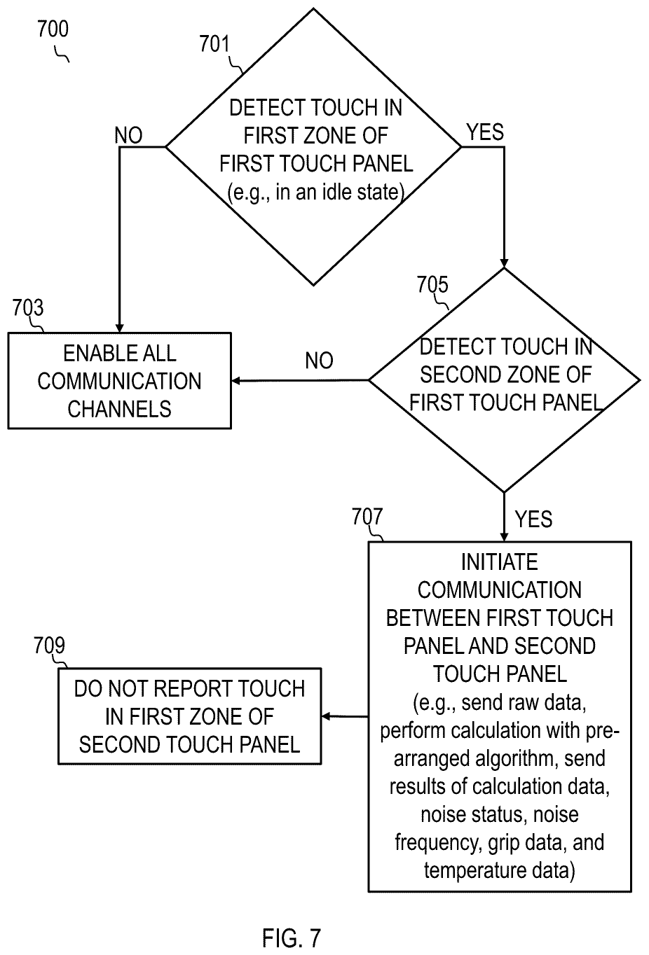

FIG. 7 shows a flowchart of a method of operating a dual-sided touch screen device according to an embodiment of the present application.

The flowchart 700 of the method for operating a dual-sided touch screen device will be described in conjunction with FIGS. 1A-1B, 2A-2B, 3A-3B, and 4A-4C. The process begins with step 701 where the touch sensors detect touch in a first zone on a first touch panel. The first touch panel may be the inner touch panel or the outer touch panel. For simplicity, the first touch panel will be described as the outer touch panel. The first zone of the outer touch panel 102 may be a zone that corresponds to a user's hand position on the outer touch panel 102 when the user intends to make a selection on the inner touch panel 104. For example, the first zone may be the zone where the user's fingers are on the outer touch panel as shown in FIGS. 5A-5C.

If touch is not detected, the process moves to step 703 where all communication channels are enabled on the inner touch panel, outer touch panel, or both touch panels. On the other hand, if touch is detected in the first zone on the outer touch panel, the process moves to step 705 where the touch sensors detect touch in a second zone on the first touch panel. The second zone of the first touch panel may be a zone on the outer touch panel when the user does not intend to make a selection on the inner touch panel. For example, the second zone of the first touch panel may be the zone where the user's fingers and palm are on the outer touch panel as shown in FIGS. 4A-4C.

If touch is not detected in the second zone, the process moves to step 703 where all communication channels are enabled on the inner touch panel, outer touch panel, or both touch panels. If touch is detected in the second zone on the outer touch panel, the process moves to step 707 where communication is initiated between the first touch panel and a second touch panel. In one or more embodiments, communication between the first touch panel and the second touch panel includes zone data or grip information which indicates whether the user intends to make a selection on the inner touch panel. The second touch panel may be the inner touch panel or the outer touch panel. For simplicity, the second touch panel will be described as the inner touch panel.

The first touch panel and the second touch panel may communicate via corresponding touch controllers through a host or directly between the touch controllers. The outer touch panel sends the zone touch data or grip information to the inner touch panel. The inner touch panel 104 receives the zone data from the outer touch panel 102 and disables a first zone of the inner touch panel. The first zone of the inner touch panel corresponds to a user's hand position on the inner touch panel when the user does not intend to make a selection on the inner touch panel. For example, when a user is holding the touch screen device, the user's thumb may be in the contact with the inner touch panel in order to grasp the device. In this example, the second zone may be a corner or edge of the device where the user's thumb is in contact with the inner touch panel as shown in FIGS. 4A-4C.

Example embodiments of the invention are described below. Other embodiments can also be understood from the entirety of the specification as well as the claims filed herein.

Example 1. A first example comprises a touch screen device that includes a first touch panel having a first main touch surface, a first touch controller coupled to the first touch panel, a second touch panel having a second main touch surface arranged opposite from the first main touch surface of the first touch panel, and a second touch controller coupled to the second touch panel and configured to receive data from the first touch controller, to perform a calculation on the received data, and to send a result of the calculation data to the first touch controller.

Example 2. The device of example 1, the first touch controller being configured to detect touch on the first touch panel while in an idle state and send data to the second touch controller and the second touch controller can determines when to disable a zone of touch channels on the second touch panel.

Example 3. The device of examples 1 and 2, the second touch controller can be configured to calculate data with a pre-arranged algorithm.

Example 4. The device of examples 1 to 3, the data includes noise status, noise frequency, grip data, and temperature data.

Example 5. The device of examples 1 to 4, the grip data can be based on a shape or characteristic of the touch screen device.

Example 6. The device of examples 1 to 5 can include a host, where the second touch controller receives data from the first touch controller through the host.

Example 7. The device of examples 1 to 6, the second touch controller can receive data from the first touch controller using auxiliary I2C (Inter-Integrated Circuits), I3C (Improved Inter Integrated Circuit), or SPI (Serial Peripheral Interface) channels.

Example 8. The device of examples 1 to 7 can include a hinge located between a first edge of the first touch panel and a first edge of the second touch panel, where the touch screen device is a foldable touch screen device.

Example 9. The device of examples 1 to 8, further includes additional touch controllers configured to receive data from the first touch controller or the second touch controller, to perform a calculation on the received data, and to send a result of the calculation data to the corresponding first touch controller or second touch controller.

Example 10. The device of examples 1 to 9, the first controller is configured to receive data from the second touch controller, to perform a calculation on the received data, and to send a result of the calculation data to the second touch controller

Example 11. A second example comprises a touch screen device that includes a first touch panel having a first main touch surface, a first touch controller configured to detect touch on the first touch panel, a second touch panel having a second main touch surface arranged opposite from the first main touch surface of the first touch panel, and a second touch controller configured to detect touch on the second touch panel. The first touch controller can be configured to communicate with the second touch controller to disable a zone of touch channels on the second touch panel when touch is detected on a zone of touch channels on the first touch panel.

Example 12. The device of example 11, the first touch controller can be configured to detect touch on the first touch panel while in an idle state and send data to the second touch controller and the second touch controller can determine when to disable the zone of touch channels on the second touch panel.

Example 13. The device of examples 11 and 12, the second touch controller can be configured to calculate the data with a pre-arranged algorithm and send the calculated data to the first touch controller.

Example 14. The device of examples 11 to 13, the first touch controller can be configured to send noise status, noise frequency, grip data, and temperature data to the second touch controller.

Example 15. The device of examples 11 to 14, the grip data is based on a shape or characteristic of the touch screen device.

Example 16. The device of examples 11 to 15 can include a host, where the first touch controller communicates with the second touch controller through the host.

Example 17. The device of examples 11 to 16, the first touch controller communicates with the second touch controller using auxiliary I2C (Inter-Integrated Circuits), I3C (Improved Inter Integrated Circuit), or SPI (Serial Peripheral Interface) channels.

Example 18. The device of examples 11 to 17 can include a hinge located between a first edge of the first touch panel and a first edge of the second touch panel, where the touch screen device is a foldable touch screen device.

Example 19. A third example comprises a method of operating a touch screen device. The method comprises detecting touch information in a first zone on a first touch panel, detecting touch information in a second zone on the first touch panel, initiating communication between the first touch panel and a second touch panel, and disabling communication channels in a first zone on the second touch panel in response to detecting touch in the first and second zone on the first touch panel. The second touch panel is arranged opposite from the first touch panel.

Example 20. The method of example 19 can further comprises calculating data from the touch information with a pre-arranged algorithm and sending the calculated data between the first touch panel and the second touch panel.

Example 21. The method of examples 19 and 20, detecting touch information can comprise detecting touch information on the first touch panel while the first touch panel is in an idle state.

Example 22. The method of examples 19 to 21, detecting the touch information can comprise detecting noise status, grip data, or temperature data.

Example 23. The method of examples 19 to 22, the grip data is based on a shape or characteristic of the touch screen device.

Example 24. The method of examples 19 to 23, initiating the communication between the first touch panel and the second touch panel can be facilitated through a host.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A touch screen device comprising:
a first touch panel having a first main touch surface;
a first touch controller coupled to the first touch panel;
a second touch panel having a second main touch surface arranged opposite from the first main touch surface of the first touch panel; and
a second touch controller coupled to the second touch panel and configured to receive data from the first touch controller when the second touch panel is in an active state and the first touch panel in an idle state, to perform a calculation on the received data from the first touch controller, and to send a result of the calculation from the second touch controller to the first touch controller, wherein the idle state is a state of inactivity.

2. The device of claim 1, wherein the first touch controller is configured to detect touch on the first touch panel while in the idle state and send the received data to the second touch controller and wherein the second touch controller is configured to determine when to disable a zone of touch channels on the second touch panel.

3. The device of claim 1, wherein the second touch controller is configured to perform the calculation on the received data with a pre-arranged algorithm.

4. The device of claim 1, wherein the received data comprises noise status, noise frequency, grip data, and temperature data.

5. The device of claim 4, wherein the grip data is based on a shape of the touch screen device.

6. The device of claim 1, further comprising a host, wherein the second touch controller is configured to receive further data from the first touch controller through the host.

7. The device of claim 1, wherein the second touch controller receives data from the first touch controller using auxiliary I2C (Inter-Integrated Circuits), I3C® (Improved Inter Integrated Circuit), or SPI (Serial Peripheral Interface) channels.

8. The device of claim 1, further comprising a hinge located between a the first touch panel and the second touch panel, wherein the touch screen device is a foldable touch screen device.

9. The device of claim 1, further comprising an additional touch controller configured to receive data from the first touch controller or the second touch controller, to perform a further calculation on the received data from the first touch controller or the second touch controller, and to send a result of the further calculation to the corresponding first touch controller or second touch controller.

10. The device of claim 1, wherein the first touch controller is further configured to receive data from the second touch controller, to perform a further calculation on the data received from the second touch controller, and to send a result of the further calculation to the second touch controller.

11. A touch screen device comprising:
a first touch panel having a first main touch surface;
a first touch controller configured to detect touch on the first touch panel;
a second touch panel having a second main touch surface arranged opposite from the first main touch surface of the first touch panel; and
a second touch controller configured to detect touch on the second touch panel;
wherein the first touch controller is configured to communicate with the second touch controller to disable a zone of touch channels on the second touch panel when touch is detected on a zone of touch channels on the first touch panel while the first touch panel is in an idle state and the second touch panel is in an active state, wherein the idle state is a state of inactivity.

12. The device of claim 11, wherein the first touch controller is configured to detect touch on the first touch panel while in the idle state and send data to the second touch controller after detecting the touch and wherein the second touch controller is configured to determine when to disable the zone of touch channels on the second touch panel in response to receiving the data.

13. The device of claim 12, wherein the second touch controller is configured to perform a calculation on the data with a pre-arranged algorithm, and send a result of the calculation to the first touch controller.

14. The device of claim 11, wherein the first touch controller is configured to send noise status, noise frequency, grip data, and temperature data to the second touch controller.

15. The device of claim 14, wherein the grip data is based on a shape of the touch screen device.

16. The device of claim 11, further comprising a host, wherein the first touch controller is configured to communicate with the second touch controller through the host.

17. The device of claim 11, wherein the first touch controller is configured to communicate with the second touch controller using auxiliary I2C (Inter-Integrated Circuits), I3C® (Improved Inter Integrated Circuit), or SPI (Serial Peripheral Interface) channels.

18. The device of claim 11, further comprising a hinge located between the first touch panel and the second touch panel, wherein the touch screen device is a foldable touch screen device.

19. A method of operating a touch screen device, the method comprising:
detecting touch information in a first zone on a first touch panel while the first touch panel is in an idle state, wherein the idle state is a state of inactivity;
detecting touch information in a second zone on the first touch panel while the first touch panel is in the idle state;
initiating communication between the first touch panel and a second touch panel while the second touch panel is in an active state, the second touch panel arranged opposite from the first touch panel; and
disabling communication channels in a third zone on the second touch panel in response to detecting touch in the first and second zone on the first touch panel, the disabling occurring while the first touch panel is in the idle state and the second touch panel is in an active state.

20. The method of claim 19, further comprising:
calculating data from the touch information in the first zone or the touch information in the second zone with a pre-arranged algorithm; and
sending the calculated data between the first touch panel and the second touch panel.

21. (canceled)

22. The method of claim 19, wherein detecting the touch information in the first zone comprises detecting noise status, grip data, or temperature data.

23. The method of claim 22, wherein the grip data is based on a shape of the touch screen device.

24. The method of claim 19, wherein initiating the communication between the first touch panel and the second touch panel comprises communicating between the first touch panel and the second touch panel through a host.

25. The method of claim 19, wherein initiating the communication between the first touch panel and the second touch panel comprises communicating directly between the first touch panel and the second touch panel.
